(19) United States
(12) Patent Application Publication
(10) Pub. No.: US 2021/0316394 A1
(43) Pub. Date: Oct. 14, 2021

(54) Laser Cutter and Safe Power System Therefor

(71) Applicant: Robert Bosch GmbH, Stuttgart (DE)

(72) Inventors: Gregory A. Herman, Elk Grove Village, IL (US); James Randall Cooper, San Diego, CA (US); Walter Bernardi, Highland Park, IL (US); Bradley D. Padget, Huntley, IL (US); Richard M. Ness, San Diego, CA (US); Emory Wheeler, Alpine, CA (US)

(21) Appl. No.: 17/269,804

(22) PCT Filed: Aug. 23, 2019
(86) PCT No.: PCT/US2019/047820

§ 371 Date: Feb. 19, 2021

Related U.S. Application Data
(60) Provisional application No. 62/722,233, filed on Aug. 24, 2018.

(51) Int. Cl. B23K 26/0622; B23K 26/08; B23K 26/12; B23K 26/38; B23K 26/70; B23K 37/00

(52) U.S. Cl. CPC B23K 26/0622; B23K 26/0876; B23K 37/006; B23K 26/38; B23K 26/702; B23K 26/127

(57) ABSTRACT

A laser cutter and safe power system therefor are disclosed. The power system of the laser cutter includes a resistive device arranged in a return line and configured to prevent anomalous tripping of a GFCI device by significantly minimizing electrical noise transmitted through the GFCI device when the laser cutter is operated in certain modes, such as a pulsing mode. The resistive device includes end caps that form a shroud around the connection between a return wire and the contact at each end of the resistive device. A main control board for a high voltage subsystem of the power system includes two isolated and independent enable signals, which are provided to different controllers on the main control board such that the different controllers can independently and redundantly respond to an unsafe condition.

This application claims the benefit of U.S. Provisional Application 62/722,233, filed Aug. 24, 2018, the disclosure of which is incorporated herein by reference in its entirety.

### TECHNICAL FIELD

The system disclosed in this document relates to laser cutters and, more particularly, to safe power systems for laser cutters.

### BACKGROUND

Laser cutting systems utilize a high energy laser beam to cut, drill, or engrave a workpiece. The high energy laser beam is generated with one or more laser tubes operated at a very high voltage. Normal operation of the laser cutting system comes with many safety concerns such as infrared radiation, very high voltages and currents, fires, and air contaminants, each of which may risk injury to the user or damage to the laser cutting system itself. Accordingly, laser cutting systems are equipped with a wide variety of safety features.

Some high voltage laser cutting systems require one or more thermal management devices to regulate the temperature of electrical components in the system. For instance, a laser cutting system can include an onboard liquid cooling system that circulates liquid coolant over or through portions of the laser tube to regulate the temperature of the laser tube when operated. However, the use of liquid coolant in the high voltage laser cutting system raises the risk of injury to the user or damage to the system if the liquid coolant leaks from the cooling system. In view of this concern, it would be advantageous to provide a laser cutting system with at least one safety feature that reduces the risk of injury or damage if liquid coolant leaks within the laser cutting system. The safety feature can be an active safety feature that performs a safety action in response to a fault condition. The safety feature can also be a passive safety feature that increases safety by way of its structure alone.

The use of certain safety features can cause unexpected issues in some high voltage laser cutting systems. For example, a laser cutting system operated in certain modes (i.e., a continuous beam mode or a pulsed beam mode) can generate electrical noise that causes an active safety feature to perform its safety action even though no fault condition exists within the system. Therefore, it would be advantageous to provide a laser cutting system with a device that minimizes the electrical noise generated under certain modes so as to permit the active safety feature to perform its safety function only when a fault condition exists in the system.

### SUMMARY

A laser cutter in one embodiment includes an enclosure, a gas laser having a laser tube, the laser tube disposed within the enclosure, a power supply operably connected to the laser tube via an electrical circuit, the power supply including at least one controller configured to control a current supplied to the laser tube so as to drive the laser tube in a first operating mode, a ground-fault circuit interrupter (GFCI) device connected electrically between the power supply and an external AC power source, the GFCI device configured to detect a ground fault condition and interrupt electrical power supplied through the GFCI device when the ground fault condition is detected, and a resistive device connected in series in the electrical circuit that connects the laser tube and the power supply, the resistive device having an electrical resistance and being configured to (i) reduce an electrical noise that arises when the laser tube is driven in the first operating mode and (ii) prevent interruption of the electrical power supplied through the GFCI device caused by the electrical noise.

An end cap for a high voltage resistive device in a laser cutter in one embodiment includes a rigid peripheral wall that encircles a longitudinal axis of the end cap in a continuous manner, the peripheral wall defining an opening that extends entirely through the end cap along the longitudinal axis, and a plurality of peripherally-spaced retention members extending radially inwardly from the peripheral wall, the retention members configured to position a high voltage wire within the opening, the peripheral wall has a first end configured to abut the resistive device and a second end configured to receive dielectric material via the opening so as to completely encapsulate a connection of the wire to the resistive device, the peripheral wall and the retention members are configured to set a minimum radial thickness of the dielectric material between the connection and the peripheral wall.

A power supply for a laser cutter is disclosed. The power supply comprises a power supply circuit operably connected to a laser tube of the laser cutter and configured to provide an operating current to operate the laser tube, the power supply circuit at least having a transformer and a plurality of switches configured to drive a primary side winding of the transformer. The power supply comprises a pulse-width-modulation (PWM) controller having a command input and a first enable input, the PWM controller being configured to (i) generate at least one PWM control signal based on a command signal received at the command input and (ii) output the at least one PWM control signal in response to a first enable signal received at the first enable input having a predetermined first state. The power supply comprises a gate driver circuit having at least one control input and a second enable input, the gate driver circuit being configured to (i) receive the at least one PWM control signal from the PWM controller at the at least one control input and (ii) operate the plurality of switches in accordance with the at least one PWM control signal only in response to a second enable signal received at the second enable input having a predetermined second state. The first enable input of the PWM controller and the second enable input of the gate driver circuit are connected to independent signal sources.

### BRIEF DESCRIPTION OF THE DRAWINGS

The foregoing aspects and other features of the laser cutter and safe power supply therefor are explained in the following description, taken in connection with the accompanying drawings.

FIG. 1 is a perspective view of an optical system in the form of a laser cutter that is equipped with a power supply and a ground-fault circuit interrupter (GFCI) in accordance with one embodiment;

FIG. 2 shows a block diagram of a power system for driving a laser tube of the optical system;

FIGS. 3A-3C are perspective views of a resistive device of the optical system of FIG. 1 with the resistive device connected electrically in series with a laser tube of the laser cutter to prevent anomalous tripping of the GFCI;

FIG. 4 is a perspective view of an end cap of the resistive device of FIG. 3;

FIGS. 5-7 are respective top, side, and bottom plan views of the end cap of FIG. 4;

FIG. 8 is an enlarged detail view of the end cap of FIG. 7 showing a retaining feature protruding from an inner surface of the end cap;

FIG. 9 is another view of the end cap of FIG. 6 showing the end cap positioned on the resistive device and a wire of the laser tube retained in the retaining feature and connected to the resistive device, the end cap and dielectric material encapsulating the wire connection sectioned along a longitudinal axis of the end cap;

FIG. 10 shows an exemplary schematic diagram of a high voltage assembly for the high voltage subsystem of the power supply;

FIG. 11 shows a block diagram for a main control board for the high voltage subsystem of the power supply; and

FIG. 12 shows an exemplary schematic diagram of the main control board for the high voltage subsystem of a power supply.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

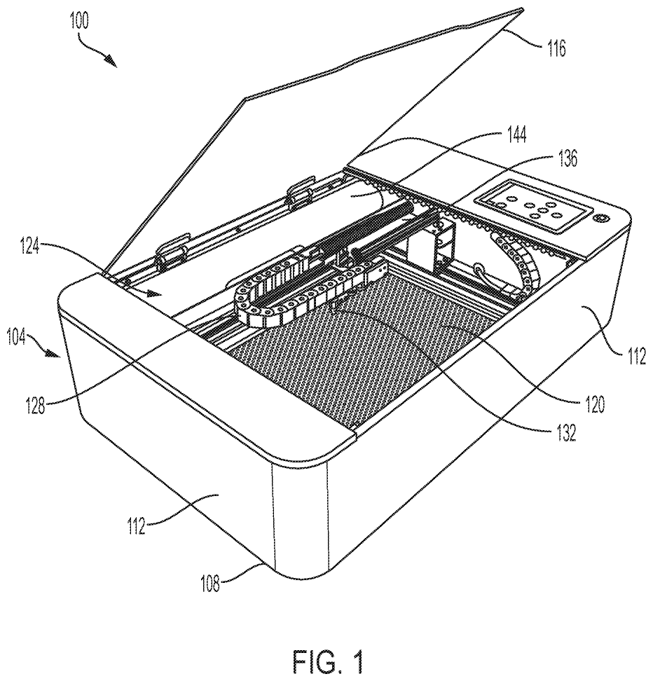

FIG. 1 depicts an optical system 100 configured to direct electromagnetic energy towards a material to cause a change in the material. In the embodiment shown in FIG. 1, the optical system is a laser cutter 100. The laser cutter 100 includes a frame 104 with a base 108, walls 112, and at least one openable barrier 116 that form an enclosure configured to partially or totally encompass the material to be changed and to restrict the egress of electromagnetic radiation from the laser cutter 100 when the laser cutter is operated. The laser cutter 100 also includes a bed or work area 120 configured to support the material.

As used herein, the terms “cut,” “cutting,” or variations thereof generally refer to altering the appearance, properties, and/or state of a material. Cutting includes, for example, making a through-cut, engraving, bleaching, curing, burning, etc. Engraving, when specifically referred to herein, indicates a process by which an optical system modifies the appearance of the material without fully penetrating it. For example, in the context of a laser cutter, engraving means mean removing some of the material from the surface, or discoloring the material, e.g. through an application of focused electromagnetic radiation delivering electromagnetic energy as described below.

As used herein, the terms “laser,” “laser beam,” or the like include any electromagnetic radiation or focused or coherent energy source that (in the context of being a cutting tool) uses photons to modify a substrate or cause some change or alteration upon a material impacted by the photons. Lasers (whether cutting tools or diagnostic) can be of any desired wavelength, including for example, microwave, lasers, infrared lasers, visible lasers, UV lasers, X-ray lasers, gamma-ray lasers, or the like. Also, as used herein, unless otherwise specified, the term “material” is the material that is on the work area 120 of the laser cutter 100. For example, the material is what is placed in the laser cutter 100 to be cut, for example, the raw materials, stock, or the like.

In the embodiment of FIG. 1, the openable barrier 116 allows access between an exterior of the laser cutter 100 and an interior space of the laser cutter 100. The openable barrier 116 can include, for example, one or more doors, hatches, flaps, and the like that actuate between an open position and a closed position. One type of openable barrier is a lid 116 that is configured to be opened or closed to enable the material to be placed on the work area 120. In addition to the lid 116, there can be additional vents, ducts, or other access points to the interior space or to components of the laser cutter 100. These access points can provide access to power, air, water, data, or the like for the laser cutter 100. In some embodiments, these additional access points are monitored such that if they are accessed unexpectedly, the laser cutter 100 can execute actions to maintain the safety of the user and the optics system, for example, execution of a controlled shutdown.

The laser cutter 100 further includes an emitter 124, a beam routing system 128, and at least one movable head 132. The emitter 124 is configured to generate the electromagnetic radiation for use by the laser cutter 100. In the embodiment shown, the emitter is a carbon dioxide (CO2) laser tube configured to emit a laser beam of approximately 40 watts from the laser tube 124. The laser tube 124 in other embodiments can be based on other types of configurations used to generate beams having other powers. The beam routing system 128 includes optical elements such as lenses and mirrors to route the beam from the laser tube 124 to the material on the work area 120. The head 132 is configured to receive the beam from the beam routing system 128 and deliver it to the material on the work area 120.

The head 132, in some embodiments, includes a combination of optics, electronics, and mechanical systems that, in response to commands, cause the beam or electromagnetic radiation to be delivered to cut or engrave the material on the work area 120. The laser cutter 100 can also execute operation of a motion plan for causing movement of the head 132. As the head 132 moves, the head 132 delivers electromagnetic energy to effect a change in the material that is at least partially contained within the interior space of the frame 104. In one embodiment, the position and orientation of the optical elements inside one or more of the beam routing system 128 and the head 132 are varied to adjust one or more of the position, angle, and focal point of the laser beam, for example, by shifting mirrors or translating lenses.

The head 132 in the embodiment shown is mounted on at least one rail 136 that is configured to move the head 132 throughout the enclosure. In some embodiments, the motion of the head 132 is linear, for example, on an X axis, a Y axis, or a Z axis. In other embodiments, the head 132 combines motions along any combination of directions in a rectilinear, cylindrical, or spherical coordinate system. The rail 136 is configured as any type of translating mechanism that enables movement of the head 132 in the X-Y direction, for example, a single rail with a motor that slides the head 132 along the rail 136, a combination of two rails that move the head 132, a combination of circular plates and rails, a robotic arm with joints, or the like.

The laser cutter 100 further includes additional components and systems that enable safe and efficient operation of the laser cutter 100 such as at least one power supply 140, a cooling system 144, and a ventilation system (not shown). The at least one power supply 140, discussed in more detail below, is a high-voltage power supply configured to drive the laser tube 124. The cooling system 144 can be a closed-loop, self-contained internal cooling system, a water-cooled cooling system, or the like and is configured to cool the laser tube 124 and associated components. The ventilation system is configured to provide airflow through the enclosure to evacuate byproducts of the laser cutter's interaction with the material such as smoke and other particulates.

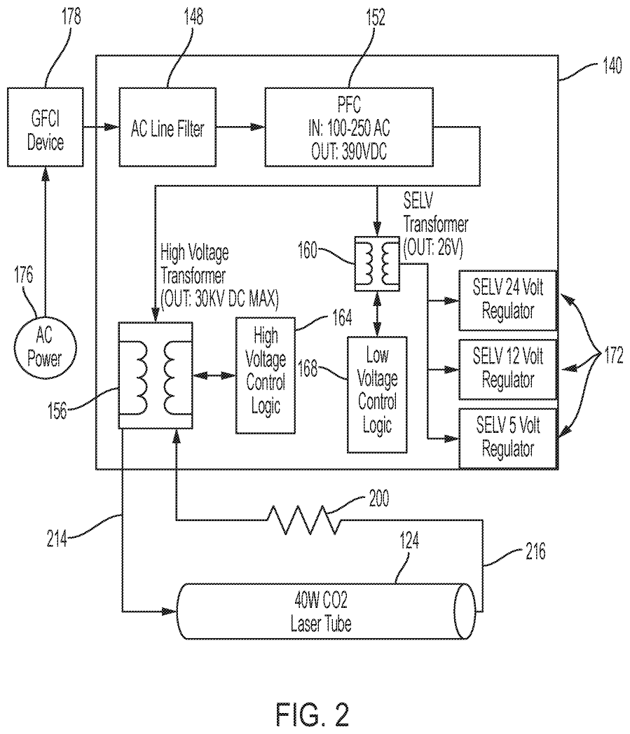

The laser cutter 100 further includes a safety system that enables the laser cutter 100 to achieve certification from Underwriters Laboratories (UL) to ensure safe operation in non-industrial environments, such as a home or a school. The safety system includes an array of smart sensors configured for real-time safety diagnostics to ensure the laser cutter operates safely at all time. The safety system also includes a ground-fault circuit interrupter (GFCI) device 178 connected electrically between an external AC power source 176 (FIG. 2) and the laser cutter 100. The GFCI device 178 in the exemplary embodiment is a standard GFCI rated for high voltage applications such as power washers. The GFCI device 178 is configured to quickly shut off or interrupt electrical power to the laser cutter 100 in the event of a ground-fault. The GFCI device 178 operates by comparing the amount of current supplied to and returned from the laser cutter 100 along the circuit conductors. The GFCI device 178 interrupts the current when the amount supplied differs from the amount returned by a predetermined threshold, for example, 5 milliamperes or more. The GFCI device 178 in one embodiment is integrated with a power cord of the laser cutter 100.

FIG. 2 shows a block diagram of a power system for driving the laser tube 124 of the laser cutter 100. The power system includes a high-voltage power supply 140 having an AC line filter 148, a power factor correction device 152, a high voltage subsystem, and a Safety Extra Low Voltage (SELV) subsystem. The AC line filter 148 is configured to filter line noise in the AC power received from the external AC power source 176. The power factor correction device 152 takes the form of a rectifier circuit configured to convert AC power received from the AC line filter 148 (e.g., 100-250V AC) into high voltage DC power (e.g., 390 Volts).

The high voltage subsystem comprises a high voltage assembly that is configured to convert the high voltage DC power (e.g., 390 Volts) from the power factor correction device 152 into much higher voltage DC power (e.g., ˜30,000 Volts) that is provided to the laser tube 124. The high voltage assembly at least includes a high voltage transformer 156, which is operated by high voltage control logic 164. In contrast, the SELV subsystem comprises an SELV assembly that is configured to convert the high voltage DC power (e.g., 390 Volts) from the power factor correction device 152 into much lower voltage DC power (e.g., 26 Volts) that is provided to SELV regulators 172. The SELV assembly at least includes an SELV transformer 160, which is operated by low voltage control logic 168. The SELV regulators 172 are configured to provide operating DC power of different levels (e.g., 24 Volt, 12 Volt, and 5 Volt) for low power electronics of the power system (e.g., the high voltage control logic 164, the low voltage control logic 168, and any other integrated circuits).

A resistive device 200 is connected electrically in series with power supply lines running between the laser tube 124 and the high voltage subsystem of the high voltage power supply 140. The power supply lines include a supply wire 214 connected to a high side of the laser tube 124 and a return wire 216 connected to a low side of the laser tube 124. In the exemplary embodiment, the resistive device 200 is disposed in the return wire 216. The resistive device 200 is configured to prevent anomalous tripping of the GFCI device 178 by significantly minimizing electrical noise transmitted through the GFCI device 178 when the laser cutter is operated in certain modes.

As described in more detail below in the discussion of the high voltage subsystem, the laser tube 124 is driven in different operating modes depending on the task performed by the laser cutter 100. It has been observed that despite the various control loops and feedbacks used to control the current supplied to the laser tube 124, operation of the laser tube 124 in a pulsing mode can generate an unexpected electrical noise that propagates through the system and causes anomalous tripping of the GFCI device 178. This unexpected electrical noise was observable by monitoring the current waveform along the return wire 216 during operation of the laser tube 124 in the pulsing mode. The current waveform was particularly erratic during the on-off switching in the pulsing mode where the waveform was observed to overshoot the target, then undershoot the target, then stabilize. The anomalous tripping of the GFCI device 178 was observed to correspond to the magnitude of the unexpected electrical noise present during pulsing mode operation. The resistive device 200 arranged in the return wire 216 stabilized the current waveform during operation of the laser tube 124 in the pulsing mode, thereby significantly reducing the electrical noise and preventing the GFCI device 178 from tripping as a result of the electrical noise.

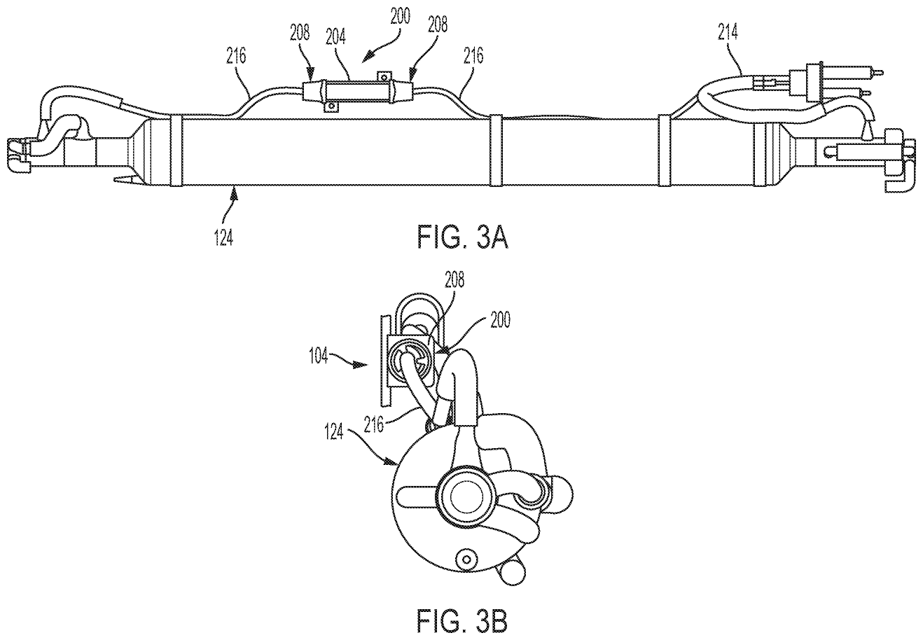

With reference to FIGS. 3A-3C, the resistive device 200 includes a housing 204, a resistive element (not shown) disposed within the housing 204, a respective contact (not shown) disposed at axial ends of the housing 204 for external connection to the resistive element, and an end cap 208 disposed at each of the axial ends of the housing 204. The resistive device 200 is located outside of the power supply 140 of the laser cutter 100. In the embodiment shown, the resistive device 200 is attached to the frame 104 of the laser cutter 100. The resistive device 200 in other embodiments can be attached to other components of the laser cutter 100 such as the laser tube 124. A pad 212 (FIG. 3C) is disposed between the resistive device 200 and the surface to which the resistive device 200 is attached to the laser cutter 100. The pad 212 is formed from a material that is both electrically insulative and thermally conductive. The thermal conductivity of the pad material 212 facilitates dissipation of heat from the resistive device 200 to the attachment surface, which is configured to act as a heat sink.

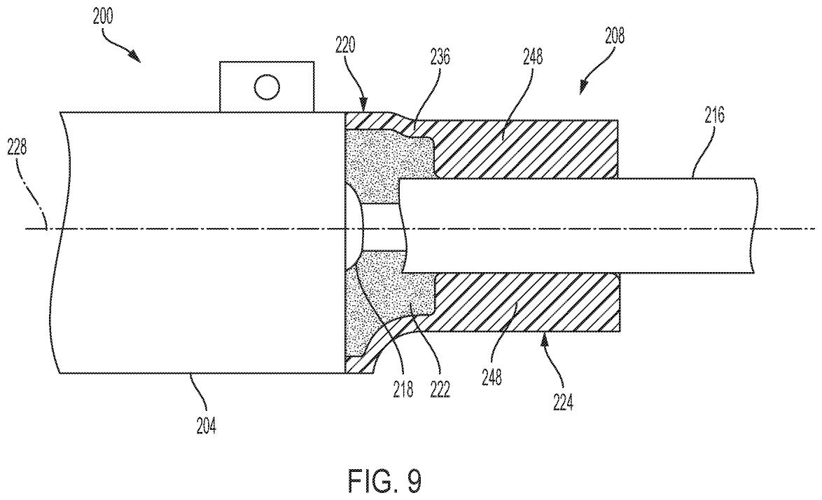

The resistive element is configured to provide an electrical resistance of approximately 50 kiloohms such that with 1000 volts across the resistive device 200, the resistive element experiences up to 20 milliamps. The resistive element in some embodiments is configured to provide a fixed electrical resistance that is greater or less than 50 kiloohms (e.g., between 40 and 60 kiloohms) as long as the resistive device 200 sufficiently minimizes the electrical noise to avoid anomalous tripping of the GFCI device 178. The pad 212 electrically isolates the resistive device 200 from the frame 104 or the laser tube 124, which are typically constructed from metal, to prevent electrical arcing between the resistive device 200 and the frame 104 or the laser tube 124. A respective wire 216 is connected to each of the contacts of the resistive device 200. With additional reference to FIG. 9, the wires 216 are connected to the contacts with solder 218 though, in other embodiments, other connection types can be utilized to electrically connect the wires 216 to the contacts of the resistive device 200. The end caps 208 form a shroud around the connection between the wire 216 and the contact at each end of the resistive device 200. A dielectric material 222 is disposed within the area shrouded by end caps 208 such that connection between the wire 216 and the contact is completely encompassed by the dielectric material.

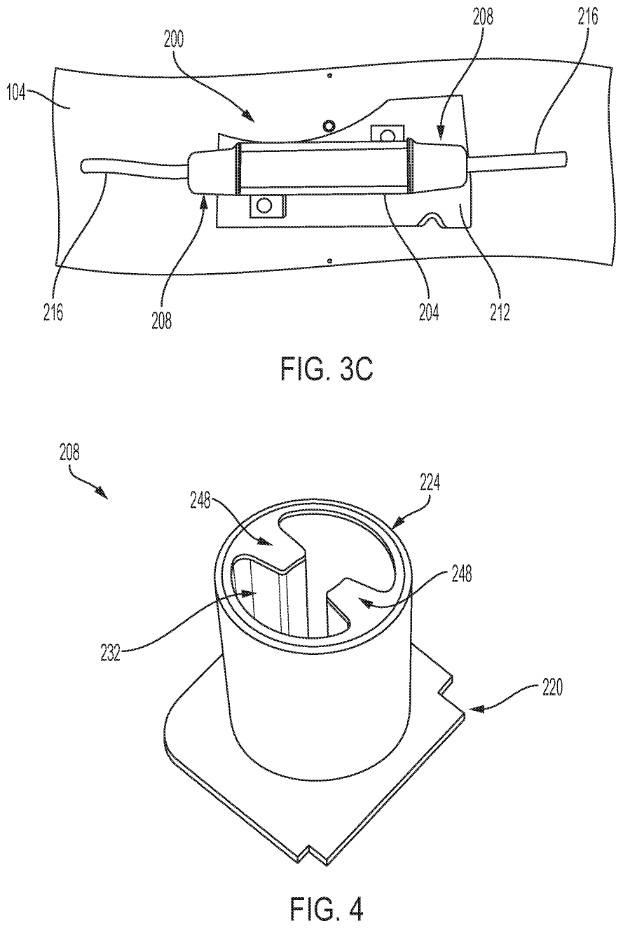

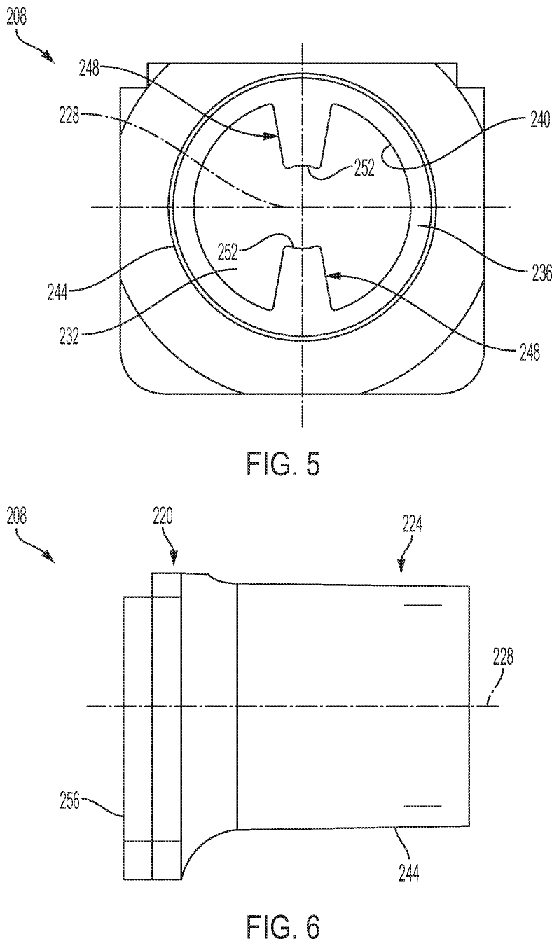

FIGS. 4-8 depict different views of one of the end caps 208 of the resistive device 200. In the embodiment shown, the end caps 208 are substantially identical although in other embodiments, the end caps can possess unique features that differentiate the end caps 208 from one another. The end cap 208 includes a peripheral wall 236 that encircles a longitudinal axis 228 of the end cap 208 and defines an opening 232 that extends through the end cap 208 along the longitudinal axis 228. As shown in FIGS. 4, 5, and 7, the peripheral wall 236 encircles the longitudinal axis 228 in a continuous manner. As used herein, the term “in a continuous manner” means that there are no interruptions, discontinuities, gaps, or the like in the structure of the element in the described path or direction of extent. The term “in a continuous manner” used in connection with the peripheral wall 236 means that the material of the peripheral wall 236 forms a continuous, unbroken ring around the longitudinal axis 228 as the peripheral wall 236 completely encircles the longitudinal axis 228.

The peripheral wall 236 has a flange portion 220 and a body portion 224 that extends from the flange portion 220 along the longitudinal axis 228. The peripheral wall 236 along the body portion 224 has an inner surface 240 and an outer surface 244 that faces opposite the inner surface 240. The peripheral wall 236 in some embodiments has a draft angle relative to the longitudinal axis 228 such that the opening 232 is slightly larger at one end of the end cap 208 than at the opposite end. One or both of the inner surface 240 and the outer surface 244 can have the draft angle. In some embodiments the draft angle facilitates the filling of the end caps 208 with the dielectric material such that no air is trapped within the dielectric material once hardened or cured.

The end cap 208 has at least one retention member 248 that extends radially inwardly from the inner surface 240 of the peripheral wall 236 towards the longitudinal axis 228. The retention member 248 is configured to position the wire 216 centrally within the end cap 208 such that the wire 216 lies substantially parallel to the longitudinal axis 228 of the end cap 208 when the wire 216 is connected to the contact of the resistive device 200 and the end cap 208 is secured to the end of the housing 204. In some embodiments, the retention member 248 positions the wire 216 such that it lies substantially parallel to and concentric with the longitudinal axis 228. The retention member 248 in one embodiment extends for a total length of the end cap 208 along the longitudinal axis 228. The retention member 248 in another embodiment extends longitudinally along a portion of the total length of the end cap 208. In yet another embodiment, the retention member 248 extends intermittently in two or more sections along the length of the end cap 208.

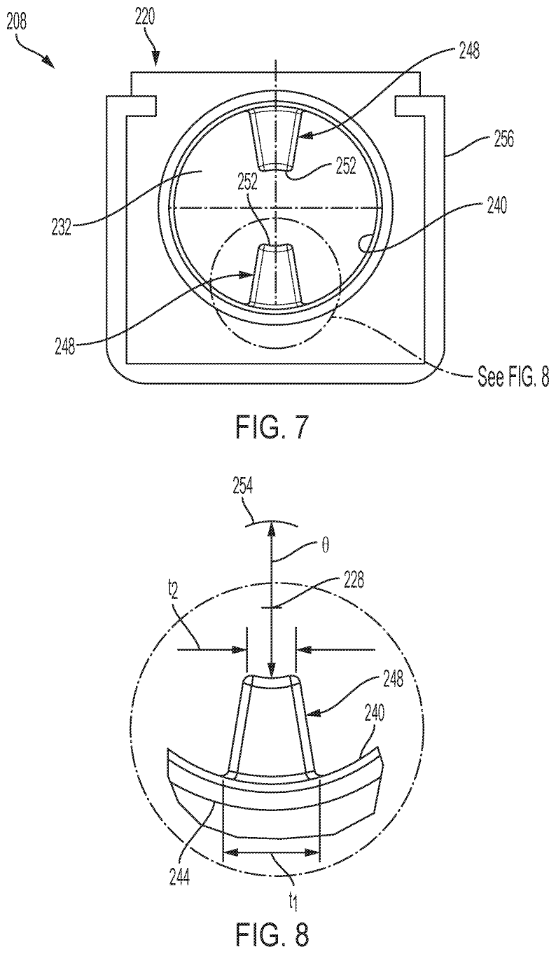

The end cap 208 in the embodiment shown has two retention members 248 that are spaced in diametric opposition from one another. In this embodiment, the retention members 248 each have a retention surface 252 that faces the retention surface 252 of the other retention member 248. The retention surfaces 252 are arcuate surfaces that, when viewed in a cross sectional plane oriented perpendicular to the longitudinal axis 228 of the end cap 208, correspond in shape to respective portions of the circumference of an imaginary circle 254 (FIG. 8) with a center point disposed concentrically with the longitudinal axis 228. In other embodiments, the retention surfaces 252 can have other shapes and features that enable the retention members 248 to retain and position the wire 216 centrally within the end cap 208.

The end cap 208 in other embodiments can have more than two retention members, for example, three or four retention members. In these other embodiments with more than two retention members, the retention members are similarly configured to position the wire 216 centrally within the end cap 208 such that the wire 216 lies substantially parallel to the longitudinal axis 228 of the end cap 208 when the wire 216 is connected to the contact of the resistive device 208 and the end cap 208 is secured to the end of the housing 204.

The flange portion 220 of the end cap 208 in some embodiments is wider than the body portion 224 in directions normal to the longitudinal axis 228 of the end cap 208 and can possess any suitable shape in these directions. In one embodiment, a rib 256 extends longitudinally from the flange portion 220 in a direction facing away from the body portion 224. The rib 256 extends along a continuous path that at least partially encircles the longitudinal axis 228 and approximates a periphery of the flange portion 220 about the longitudinal axis 228. The rib 256 in some embodiments is configured to be received by a corresponding opening in the housing 204 of the resistive device 200 so as to position the end cap 208 for secure attachment to the housing 204.

In at least one non-limiting, exemplary embodiment, the end cap 208 has an overall length dimension along the longitudinal axis of 18 mm measured from the axial most end of the body portion 224 to the axial most end of the rib 256. The peripheral wall 236 in this exemplary embodiment is annular with the outer surface 244 having a diameter of 12.5 mm and the inner surface 240 having a diameter of 10.6 mm. The imaginary circle 254 that defines the shape of the retention surfaces 252 and the spacing therebetween has a diameter θ (FIG. 8) of 4.1 mm. When viewed in a cross sectional plane oriented normal to the longitudinal axis 228, the retention members 248 each have a first thickness t1 at the intersection of the retention member 248 and the inner surface 240 of the peripheral wall 236 that is wider than a second thickness t2 of the retention member 248 at a radially innermost portion of the retention member 248 proximate to the retention surface 252. The second thickness t2 in this exemplary embodiment is 1.68 mm. The flange portion 220 in this exemplary embodiment has a generally rectangular periphery measuring 17.5 mm×17 mm. The dimensions disclosed in this exemplary embodiment should be appreciated as approximate dimensions that incorporate the customary design and manufacturing tolerances for components used in similar applications. The end cap 208 in this exemplary embodiment is formed from acrylonitrile butadiene styrene (ABS) though other materials with comparable rigidity, impact resistance, toughness, and electrical insulation properties can be used in other embodiments. The dielectric material in this exemplary embodiment is 3M™ Scotch-Weld™ Epoxy Adhesive DP100.

With reference again to FIGS. 3A-3C, the one or more retention members 248 of each end cap 208 are configured in some embodiments to permit the end cap 208 to be moved relative to the wire 216 with application of a predetermined amount of force after the wire 216 is retained by the retention members 248. As an example, the retention members 248 in one embodiment are configured to receive the wire 216 with a slight interference fit such that a user can position the end cap 208 at a first position along the wire 216, the wire 216 can then be soldered or otherwise connected to the resistive device 200, and then the end cap 208 is moved to a second position along the wire 216 and attached to the housing 204 of the resistive device 200.

With the wire 216 retained centrally within the end cap 208 and the end cap 208 attached or otherwise held to the housing 204, the dielectric material can be inserted into one or more cavities defined by one or more of the end cap 208, the housing 204, and the wire 216. In one exemplary embodiment, the end cap 208 guarantees there is 2 mm of dielectric material completely surrounding the connection between the contact of the resistive device 200 and the wire 216. The end cap 208 is further configured to enable the dielectric material to be inserted into the one or more cavities in a manner that prevents the formation of air gaps therein so as to prevent arcing from the high-voltage connections at the resistive device 200.

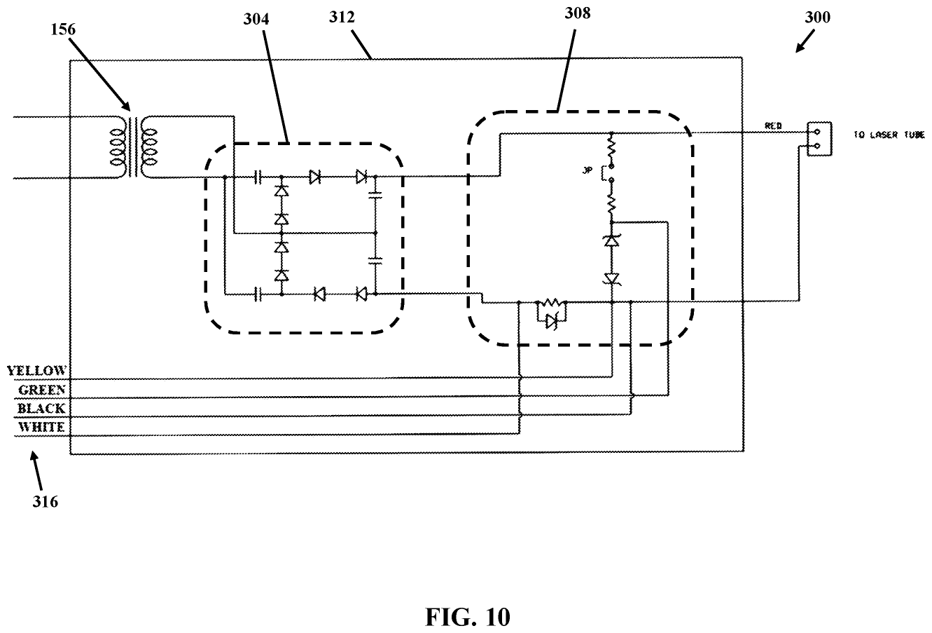

FIG. 10 shows a schematic diagram for a high voltage assembly 300 of the high voltage subsystem of the power supply 140 of the laser cutter 100. The high voltage assembly 300 includes the high voltage transformer 156, a voltage multiplier 304, and a voltage divider 308. The voltage multiplier 304 and voltage divider 308 advantageously enable the power supply 140 to be more reliable and more accurate. Additionally, in at least one embodiment, the high voltage assembly 300 is contained in an enclosure 312, which isolates the high voltage assembly 300 from other components of the power supply 140, thereby improving safety.

The voltage multiplier 304 is configured to operate in conjunction with the high voltage transformer 156 to provide a total gain for the high voltage assembly 300. Particularly, the high voltage transformer 156 receives, at a primary side winding, an AC voltage that was inverted or otherwise generated using the DC voltage (e.g., 390 Volts) from the power factor correction device 152 and is configured to provide an intermediate AC voltage (e.g., ˜8,000 Volts) on its secondary side winding. The voltage multiplier 304 is configured as a 4× voltage multiplier-rectifier such that, in conjunction with the high voltage transformer 156, it provides a rectified DC voltage (e.g., ˜30,000 Volts) as an output for driving the laser tube 124, which is much higher than the intermediate AC voltage at the secondary side winding of the high voltage transformer 156. It will be appreciated that conventional laser power supplies use only a transformer for voltage gain, then a rectifier to convert to DC. By utilizing the voltage multiplier 304, the gain required by the high voltage transformer 156 is reduced, allowing it to be smaller, more robust, and safer.

The voltage divider 308 is configured to provide real secondary side feedbacks 316 for an output voltage of the high voltage assembly 300 and an output current of the high voltage assembly 300. In particular, the voltage divider 308 provides positive and negative voltage feedback lines YELLOW and GREEN and provides positive and negative current feedback lines BLACK and WHITE. The feedback lines YELLOW, GREEN, BLACK, and WHITE are provided to the high voltage control logic 164 to enable feedback control of the output current and voltage of the high voltage assembly 300. It will be appreciated that conventional laser power supplies use primary side feedback voltages and currents from the primary side winding of the transformer to control the laser, which often require manual adjustment of potentiometers to match the actual output voltages and currents, leading to inaccuracies in the control. Additionally, it will be appreciated that the laser tube 124 is a challenging load to drive, due to its negative differential resistance (also known as negative differential conductivity). These real secondary side feedbacks 316 enable more precise control of control of the output current and voltage of the high voltage assembly 300.

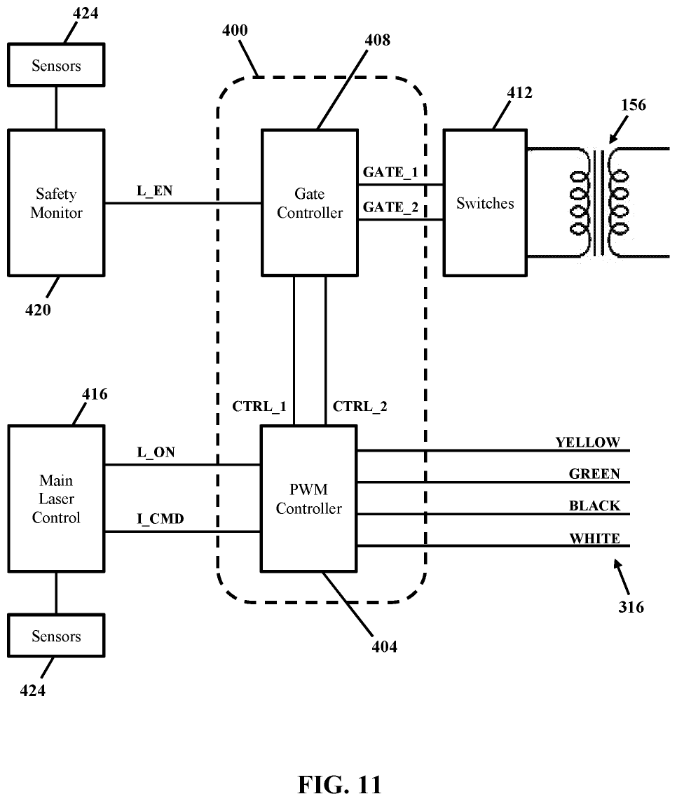

FIG. 11 shows a block diagram including a main control board 400 for the high voltage subsystem of the power supply 140, which embodies at least in part the high voltage control logic 164. The main control board 400 includes at least a pulse-width modulation (PWM) controller 404 and a gate controller 408, which together operate to control switches 412 that drive the primary side winding of the high voltage transformer 156. Particularly, in at least one embodiment, the switches 412 comprise two or more switches that form an inverter circuit configured to provide an AC voltage to the primary side winding of the high voltage transformer 156 using the DC voltage (e.g., 390 Volts) from the power factor correction device 152. The inverter circuit may, for example, take the form of a half-bridge inverter circuit or a full-bridge inverter circuit (also referred to as an H-bridge inverter circuit), but any advantageous inverter circuit design may also be utilized.

The PWM controller 404 is configured to generate control signals, which are provided to the gate controller 408 for operating the switches 412. The PWM controller 404 has a command input configured to receive a current command signal I_CMD from a main laser control 416, which is representative of a target value for a driving current that flows through the laser tube 124. Additionally, the PWM controller 404 has one or more feedback inputs configured to receive one or more of the real secondary side feedbacks 316, which may include some or all of the feedback lines YELLOW, GREEN, BLACK, and WHITE, or signals derived therefrom. Based on the current command signal I_CMD and one or more of real secondary side feedbacks 316, the PWM controller 404 is configured to generate and output PWM control signals CTRL_1 and CTRL_2 via control outputs of the PWM controller 404. In at least one embodiment, PWM controller 404 implements a closed-loop feedback control of the driving current flowing through the laser (as indicated by the feedback lines YELLOW and/or GREEN) so as to track the target value indicated by the current command signal I_CMD.

The PWM controller 404 generally comprises an integrated circuit or equivalent dedicated circuitry designed to generate PWM control signals. However, it will be appreciated that PWM controller 404 may equivalently comprise any computing device having processor and at least one associated memory having program instructions stored thereon, which are executed by the at least one processor to achieve the described functionalities. Moreover, the PWM controller 404 may be implemented in the form of a single central processing unit, multiple discrete processing units, programmable logic devices, one or more logic gates, ASIC devices, or any other suitable combination of circuitry. Thus, PWM controller 404 may comprise any hardware system, hardware mechanism, or hardware component that processes data, signals, or other information for achieving the described functionality.

The gate controller 408 (which may also be referred to herein as the “gate driver circuit”) is operably connected to each of the switches 412 and is configured to generate gate control signals configured to operate the switches as necessary to drive the high voltage transformer 156. The gate controller 408 has control inputs configured to receive the PWM control signals CTRL_1 and CTRL_2. The gate controller 408 is configured to generate gate control signals GATE_1 and GATE_2 based on the PWM control signals CTRL_1 and CTRL_2 and output the gate control signals GATE_1 and GATE_2 via control outputs of the gate controller 408.

The gate controller 408 generally comprises an integrated circuit or equivalent dedicated circuitry designed to generate gate control signals. However, it will be appreciated that gate controller 408 may equivalently comprise any computing device having processor and at least one associated memory having program instructions stored thereon, which are executed by the at least one processor to achieve the described functionalities. Moreover, the gate controller 408 may be implemented in the form of a single central processing unit, multiple discrete processing units, programmable logic devices, one or more logic gates, ASIC devices, or any other suitable combination of circuitry. Thus, gate controller 408 may comprise any hardware system, hardware mechanism, or hardware component that processes data, signals, or other information for achieving the described functionality.

With continued reference to FIG. 11, the main control board 400 includes isolated and independent enable signals L_ON and L_EN (which may also be referred to herein as safety inputs). The enable signal L_ON is provided to the PWM controller 404 and the enable signal L_EN is provided to the gate controller 408. The PWM controller 404 has an enable input configured to receive the enable signal L_ON and is configured to only generate the PWM control signals CTRL_1 and CTRL_2 in response to the enable signal L_ON having an enable state (e.g., a designated high state or low state). The PWM controller 404 is configured to stop generating the PWM control signals CTRL_1 and CTRL_2 in response to the enable signal L_ON having any state other than the enable state. Similarly, the gate controller 408 has an enable input configured to receive the enable signal L_EN and is configured to only generate the gate control signals GATE_1 and GATE_2 in response to the enable signal L_EN having an enable state (e.g., a designated high state or low state, which may of course be different than that of L_ON). The gate controller 408 is configured to stop generating the gate control signals GATE_1 and GATE_2 in response to the enable signal L_EN having any state other than the enable state.

In the exemplary embodiment, the enable signal L_ON is provided to the PWM controller 404 by the main laser control 416. The main laser control 416 is, for example, a computer and/or controller responsible for operating the laser tube 124 of the laser cutter 100 to perform a laser engraving and/or laser cutting task based on a project file or similar set of project-specific instructions. In addition to this primary function, the main laser control 416 is configured to control an on/off state of the laser tube 124 by providing the enable signal L_ON with the enable state to turn on the laser tube 124 or providing the enable signal L_ON with another state, which is different from the enable state, to turn off the laser tube 124.

Further with respect to control of the laser tube 124, the main laser control 416 is configured to operate the laser tube 124 in different modes depending in part on the type of material placed in the laser cutter 100 and the task to be performed on the material. To perform engraving, the main laser control 416 operates the laser tube 124 in a pulsing mode in which the laser tube 124 is driven to emit the laser beam in pulses that can have a maximum frequency of, for example, 1 kilohertz. To perform cutting, the main laser control 416 operates the laser tube 124 in a continuous mode in which the laser tube 124 is driven to emit the laser beam continuously (i.e. without any pulsing of the laser beam).

It will be appreciated that the laser tube 124 is essentially a current-controlled device and that a driving current is adjustable by the PWM controller 404 within a defined range, for example, between 5 and 20 milliamperes. Thus, the maximum power output is achieved in the continuous mode when the target driving current is set at 20 milliamperes. Conversely, the minimum power output is achieved in the pulsing mode when the target driving current is set at 5 milliamperes, which when pulsed at the maximum frequency is approximately equivalent to 1 milliampere.

In the exemplary embodiment, the enable signal L_EN is provided to the gate controller 408 by a safety monitor 420. Although beyond the scope of this disclosure, the safety monitor 420 is, for example, a computer and/or controller responsible for monitoring a variety of safety relevant conditions of the laser cutter 100. If the safety monitor 420 does not detect any unsafe conditions of the laser cutter 100, the safety monitor 420 is configured to provide the enable signal L_EN with the enable state to enable the laser tube 124. If the safety monitor 420 detects or determines unsafe condition of the laser cutter 100, the safety monitor 420 is configured to provide the enable signal L_EN with another state, which is different from the enable state, to disable the laser tube 124.

In at least one embodiment, one or both of the main laser control 416 and the safety monitor 420 are operably connected to one or more sensors 424 and configured to turn off and/or disable the laser tube 124 using the respective one of the enable signals L_ON and L_EN in response to detecting an unsafe condition. The sensors 424 may include a temperature sensor configured to detect an overheating condition of the laser tube 124 or other component, a door sensor configured to detect an open condition of the openable barrier 116, a leak sensor configured to detect a leaking condition of cooling system 144 (in the case of a liquid coolant based cooling system), a smoke sensor configured to detect a fire within the laser cutter 100, a voltage sensor configured to detect an over-voltage condition of some electrical component, and a current sensor configured to detect an over-current condition of some electrical component. In some cases, the sensors 424 may include redundant sensors configured to detect the same unsafe condition but which are connected to a different one of the main laser control 416 and the safety monitor 420, such that both of the main laser control 416 and the safety monitor 420 are configured to detect a particular unsafe condition independently and redundantly.

It will be appreciated that conventional laser power supplies use control inputs that all route to the same controller chip. This means that a failure of that chip could result in uncontrolled laser emission from the laser tube 124. In contrast, the main control board 400 uses redundant and fault tolerant safety inputs. All three main inputs are required to be valid to fire the laser (I_CMD, L_ON, and L_EN). If there is a safety critical problem, two will deactivate immediately (L_ON and L_EN), shutting down two different parts of the power system, including the switches 412 that drive the high voltage transformer 156, both individually resulting in a shutdown of the laser tube 124.

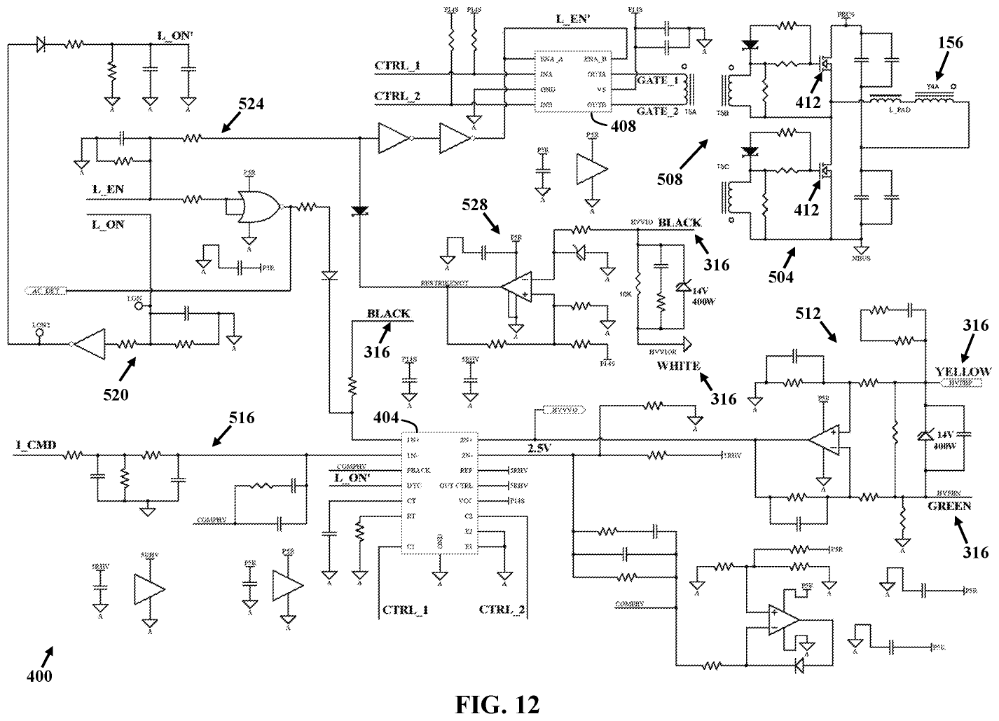

FIG. 12 shows an exemplary schematic diagram of the main control board 400 for the high voltage subsystem of the power supply. As can be seen, the exemplary schematic diagram of FIG. 12 includes numerous additional circuit components other than the PWM controller 404 and the gate controller 408. The additional circuit components illustrated in the exemplary schematic diagram serve various purposes such as biasing or conditioning the signals received by or output by the PWM controller 404 and the gate controller 408. In most instances, the particular arrangement of the additional circuit components are but one of many suitable and equivalent circuit arrangements that might be utilized to achieve the intended biasing, conditioning, or other function. Accordingly, the particular circuit arrangements illustrated are not described in complete detail and only certain notable features are discussed.

In the particular exemplary embodiment illustrated in FIG. 12, the switches 412 are power MOSFET switches arranged to form a half-bridge inverter 504, which drives the primary side winding of the high voltage transformer 156. Since the half-bridge inverter 504 and the gate controller 408 operate with substantially different operating voltages, the half-bridge inverter 504 is electrically isolated from the gate controller 408, thereby improving safety and minimizing risk of damage to the main control board 400. In particular, the gate control signals GATE_1 and GATE_2 are provided to the gates of the power MOSFET switches 412 in an electrically isolated manner via a transformer 508.

In the particular exemplary embodiment illustrated in FIG. 12, the feedback lines YELLOW and GREEN, which represent the real secondary side output voltage feedbacks 316, are not provided directly to the PWM controller 404. Instead, the feedback lines YELLOW and GREEN are provided to a comparator circuit 512. In one embodiment, the comparator circuit 512 is configured to output a voltage feedback signal having a predetermined state in response to the feedback voltage exceeding a predetermined over-voltage threshold. In one embodiment, the comparator circuit 512 is configured to scale down a magnitude of the output voltage feedback signal by a predetermined factor (e.g., 10000:1) such that the output voltage feedback signal is within a predetermined range (e.g., 0-2.5 V) suitable for receipt by the PWM controller 404. Additionally, with respect to the feedback lines BLACK and WHITE, which represent the real secondary side output current feedbacks 316, only the feedback line BLACK is provided to the PWM controller 404 and the feedback line WHITE is not utilized.

In the particular exemplary embodiment illustrated in FIG. 12, the command signal I_CMD is not provided directly to the PWM controller 404. Instead, the command signal I_CMD is provided to a conditioning circuit 516, which then provides the command signal I_CMD in a conditioned form to the PWM controller 404. Similarly, the enable signal L_ON is also not provided directly to the PWM controller 404. Instead, the enable signal L_ON is provided to a conditioning circuit 520, which then provides the enable signal L_ON in a conditioned form (denoted L_ON′) to the PWM controller 404. Additionally, in the particular exemplary embodiment illustrated in FIG. 12, the conditioned enable signal L_ON′ is provided to a dead time control (DTC) input of the PWM controller 404, in lieu of a dedicated enable input. Finally, the enable signal L_EN is not provided directly to the gate controller 408. Instead, the enable signal L_EN is provided to a conditioning circuit 524, which then provides the enable signal L_EN in a conditioned form (denoted L_EN′) to the gate controller 408.

In the particular exemplary embodiment illustrated in FIG. 12, the feedback lines BLACK and WHITE, which represent the real secondary side output current feedbacks 316, are also provided to a comparator circuit 528 configured to pull down the enable signal L_EN (so as to disable the gate controller 408) via a diode in response to the current flowing through the laser tube exceeding a predetermined over-current threshold. In this way, the comparator circuit 528 acts as an additional safety mechanism that will disable the laser tube 124 if there is an unsafe condition.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A laser cutter, comprising:
an enclosure;
a gas laser having a laser tube, the laser tube disposed within the enclosure;
a power supply operably connected to the laser tube via an electrical circuit disposed between the laser tube and an external connection to the power supply, the power supply including at least one controller configured to control a current supplied to the laser tube so as to drive the laser tube in a first operating mode;
a ground-fault circuit interrupter (GFCI) device connected electrically between the power supply and an external AC power source, the GFCI device configured to detect a ground fault condition and interrupt electrical power supplied through the GFCI device when the ground fault condition is detected; and
a resistive device connected in series in the electrical circuit, the resistive device having an electrical resistance and being configured to (i) reduce an electrical noise that arises when the laser tube is driven in the first operating mode and (ii) prevent interruption of the electrical power supplied through the GFCI device caused by the electrical noise.

2. The laser cutter of claim 1, wherein the electrical circuit includes a supply line connected to an input of the laser tube and a return line connected to an output of the laser tube, the resistive device disposed in the return line.

3. The laser cutter of claim 1, wherein the first operating mode is a pulsing mode in which the laser tube is driven to emit a laser beam in pulses, the resistive device stabilizing a waveform of the current returned from the laser tube when driven in the pulsing mode so as to reduce the electrical noise.

4. The laser cutter of claim 3, wherein the controller is further configured to drive the laser tube in a second operating mode, the second operating mode being a continuous mode in which the laser tube is driven to emit the laser beam continuously.

5. The laser cutter of claim 1, wherein the resistive device includes a housing mounted to one of the enclosure and the laser tube, a pad configured to be electrically insulative and thermally conductive is disposed between the resistive device and the one of the enclosure and the laser tube.

6. The laser cutter of claim 5, wherein the housing is mounted to the laser tube, the laser cutter further comprising a cooling system configured to circulate a liquid coolant so as to contact at least a portion of the laser tube and cool the laser tube and the resistive device.

7. The laser cutter of claim 5, wherein the housing is mounted to a metal portion of the enclosure, the metal portion configured as a heat sink to cool the resistive device.

8. An end cap for a high voltage resistive device in a laser cutter, the end cap comprising:
a rigid peripheral wall that encircles a longitudinal axis of the end cap in a continuous manner, the peripheral wall defining an opening that extends entirely through the end cap along the longitudinal axis; and
a plurality of peripherally-spaced retention members extending radially inwardly from the peripheral wall, the retention members configured to position a high voltage wire within the opening,
wherein the peripheral wall has a first end configured to abut the resistive device and a second end configured to receive dielectric material via the opening so as to completely encapsulate a connection of the wire to the resistive device, the peripheral wall and the retention members configured to set a minimum radial thickness of the dielectric material between the connection and the peripheral wall.

9. The end cap of claim 8, wherein the retention members are configured to slidably receive the wire in a direction parallel to the longitudinal axis.

10. The end cap of claim 8, wherein the retention members are flush with the second end of the peripheral wall and extend longitudinally from the second end towards the first end of the peripheral wall.

11. The end cap of claim 10, wherein at least one of the retention members extends from the second end in a continuous manner and does not overlap the connection when the first end abuts the resistive device.

12. The end cap of claim 10, wherein at least one of the retention members extends from the second end in a continuous manner and overlaps the connection when the first end abuts the resistive device.

13. The end cap of claim 8, wherein at least one of the retention members has a retention surface configured to contact the wire, the retention surface having a shape that, when viewed in a cross sectional plane oriented perpendicular to the longitudinal axis, corresponds to a portion of the circumference of an imaginary circle with a center point concentric with the longitudinal axis.

14. The end cap of claim 8, wherein the peripheral wall has a flange portion disposed at the first end and a body portion that extends longitudinally from the flange portion and defines the second end, the flange portion having an alignment feature that cooperates with the resistive device to align the end cap relative to the resistive device, the body portion having an inner surface with an annular shape that sets the minimum radial thickness of the dielectric material.

15. A power supply for a laser cutter, the power supply comprising:
a power supply circuit operably connected to a laser tube of the laser cutter and configured to provide an operating current to operate the laser tube, the power supply circuit at least having a transformer and a plurality of switches configured to drive a primary side winding of the transformer;
a pulse-width-modulation (PWM) controller having a command input and a first enable input, the PWM controller being configured to (i) generate at least one PWM control signal based on a command signal received at the command input and (ii) output the at least one PWM control signal in response to a first enable signal received at the first enable input having a predetermined first state; and
a gate driver circuit having at least one control input and a second enable input, the gate driver circuit being configured to (i) receive the at least one PWM control signal from the PWM controller at the at least one control input and (ii) operate the plurality of switches in accordance with the at least one PWM control signal only in response to a second enable signal received at the second enable input having a predetermined second state,
wherein the first enable input of the PWM controller and the second enable input of the gate driver circuit are connected to independent signal sources.

16. The power supply of claim 15, wherein:
the PWM controller is configured to cease outputting the at least one PWM control signal in response to the first enable signal having any state other than the predetermined first state; and
the gate driver circuit is configured to cease outputting the PWM control signals in response to the first enable signal having any state other than the predetermined second state.

17. The power supply of claim 15, wherein the PWM controller receives the first enable signal from a first controller of the laser cutter and the gate driver circuit receives second enable signal from a second controller of the laser cutter, the first controller and the second controller being configured to generate the first enable signal and the second enable signal, respectively, independently of one another.

18. The power supply of claim 17, wherein the first controller is configured to generate the first enable signal based on a first sensor signal of a first sensor and the second controller is configured to generate the second enable signal based on a second sensor signal of a second sensor.

19. The power supply of claim 17, wherein the first sensor and the second sensor are configured to independently sense a same condition of the laser cutter.

20. The power supply of claim 17, wherein the PWM controller receives the command signal from one of the first controller and the second controller.
